(19) United States
(12) Patent Application Publication
(10) Pub. No.: US 2020/0146523 A1
(43) Pub. Date: May 14, 2020

(54) AUTONOMOUS CLEANER

(71) Applicant: Panasonic Intellectual Property Management Co., Ltd., Osaka (JP)

(72) Inventors: Shinya FUJIEDA, Shiga (JP); Masaki KOGA, Shiga (JP)

(21) Appl. No.: 16/627,491

(22) PCT Filed: May 28, 2018
(86) PCT No.: PCT/JP2018/020252

§ 371 Date: Dec. 30, 2019

(30) Foreign Application Priority Data
Aug. 31, 2017 (JP) 2017-166337

(51) Int. Cl. A47L 11/19; A47L 11/24; G05D 1/02; A47L 9/06; A47L 9/04

(52) U.S. Cl. CPC A47L 11/19; A47L 11/24; G05D 1/0219; G05D 2201/0203; A47L 9/0411; A47L 2201/06; A47L 9/0613

(57) ABSTRACT

An autonomous cleaner includes a side brush that is provided to a bottom face of a body and sweeps up dust on a floor surface and a napped cleaning fabric that is provided in a rotating region of the side brush and wipes off the dust attached to the side brush. The side brush includes a brush shaft disposed at a position that is a predetermined distance above the floor surface and a pair of bristle bundles having different lengths. A shorter bristle bundle in the pair has a length that is sufficient to bring at least a tip end portion of the shorter bristle bundle into contact with the napped cleaning fabric. In this way, the dust attached to the side brush is wiped off by the napped cleaning fabric, which prevents the dust from being swept outside the body due to a centrifugal force. In addition, by disposing the brush shaft at a predetermined distance from the floor surface, it is possible to suppress entanglement with a carpet and the like and avoid a collision with a step. As a result, it is possible to provide the autonomous cleaner having a longer life and requiring infrequent maintenance.

### TECHNICAL FIELD

The present invention relates to an autonomous cleaner.

### BACKGROUND ART

Conventionally, an autonomous cleaner having a body, drive units, a main brush, a suction unit, side brushes, and the like is disclosed (see Patent Literatures 1 to 4, for example). The body of the autonomous cleaner is mounted with various kinds of component elements. The drive units move the body. The main brush is disposed at a suction port formed in the body and collects litter existing on a surface to be cleaned. The suction unit draws in the litter through the suction port in the body. The side brush collects the litter on a floor surface existing under a bodywork bottom face of the body. In other words, the autonomous cleaner is formed to rotate the side brushes to collect dust such as the litter on the surface to be cleaned and guide the dust into the suction port.

The prior-art autonomous cleaner described in each of the patent literatures rotates the side brushes provided to a front part of the bodywork bottom face of the body to collect the dust on the floor surface. Therefore, a major part of the dust raked up with the side brushes is collected through the suction port in the bottom face of the body.

However, a part of the dust attached to the side brushes may be swept outside the bodywork again and scattered on the floor surface due to centrifugal forces generated by the rotation of the side brushes.

Moreover, the side brushes are provided to a front side of the bodywork bottom face of the body to exert higher dust collecting performance on the floor surface. The side brushes rotate at positions relatively close to the floor surface. Therefore, a carpet or fibrous dust easily gets entangled with each of the side brushes. If entanglement strong enough to lock the rotation of the side brush occurs, stress due to rotational driving of a motor is directly applied to a base (bonded part) of the side brush. As a result, planted bristle bundles are liable to curl or fall out.

### CITATION LIST

### Patent Literatures

PTL 1: Unexamined Japanese Patent Publication No. 2012-231937

PTL 2: Unexamined Japanese Patent Publication No. 2013-146303

PTL 3: Unexamined Japanese Patent Publication No. 2016-116541

PTL 4: Unexamined Japanese Patent Publication No. 2016-154597

### SUMMARY OF THE INVENTION

The present invention provides an autonomous cleaner with which dust is not swept outside a bodywork again due to rotation of side brushes. The present invention also provides an autonomous cleaner with which entanglement of dust with side brushes can be prevented and life of bristle bundles of the side brushes can be extended.

An autonomous cleaner according to the present invention includes a body, a side brush that is provided to a bottom face of the body and sweeps up dust on a floor surface, and a napped cleaning fabric that is provided in a rotating region of the side brush and wipes off the dust attached to the side brush. The side brush includes a brush shaft disposed at a position that is a predetermined distance above the floor surface and a pair of bristle bundles having different lengths. A shorter bristle bundle in the pair is formed to have a length that is sufficient to bring at least a tip end portion of the shorter bristle bundle into contact with the napped cleaning fabric.

With this structure, the dust attached to the side brush is wiped off by the napped cleaning fabric during rotation. Therefore, it is possible to prevent the dust attached to the side brush from being swept outside the body again due to a centrifugal force.

The brush shaft of the side brush is disposed at the position that is the predetermined distance above the floor surface. As a result, it is possible to suppress entanglement of the carpet and the like with the brush shaft. Moreover, it is possible to substantially reduce the collisions of the brush shaft of the side brush with the step during climbing over of the step. As a result, it is possible to prevent the brush shaft from getting scratched or damaged.

The bristle bundle provided to the side brush is short because the bristle bundle has a length that is just enough to bring the tip end portion of the bristle bundle into contact with the napped cleaning fabric. As a result, it is possible to effectively suppress the entanglement of the dust such as hairs and fibers with the side brush. In addition, it is possible to prevent deformation of the bristle bundles of the side brush due to the entanglement of the dust. As a result, it is possible to effectively prevent occurrence of falling out and curling due to wearing out of the side brush to thereby extend life of the side brush. In this way, it is possible to substantially reduce the number of times of maintenance and replacement of the side brush.

### BRIEF DESCRIPTION OF DRAWINGS

FIG. 1 is an overall perspective view of an autonomous cleaner according to an exemplary embodiment of the present invention.

FIG. 2 is a plan view of the autonomous cleaner.

FIG. 3 is a bottom view of the autonomous cleaner.

FIG. 4 is a front view of the autonomous cleaner.

FIG. 5 is a left side view of the autonomous cleaner.

FIG. 6 is a plan view of the autonomous cleaner with a lid open.

FIG. 7 is a perspective view of the autonomous cleaner of which a litter box unit is taken out.

FIG. 8 is a perspective view of a lower unit of the autonomous cleaner.

FIG. 9 is a perspective view of an upper unit of the autonomous cleaner.

FIG. 10 is a left sectional view of the autonomous cleaner.

FIG. 11 is a left sectional view of the autonomous cleaner of which the litter box unit is taken out.

FIG. 12 is a partial view showing a rotating region of a side brush seen from a side of a bottom face of the autonomous cleaner.

FIG. 13 is a sectional view of a relevant part of the autonomous cleaner.

### DESCRIPTION OF EMBODIMENT

Hereinafter, an exemplary embodiment of the present invention is described with reference to the drawings. The present exemplary embodiment is not intended to limit the present invention.

### Exemplary Embodiment

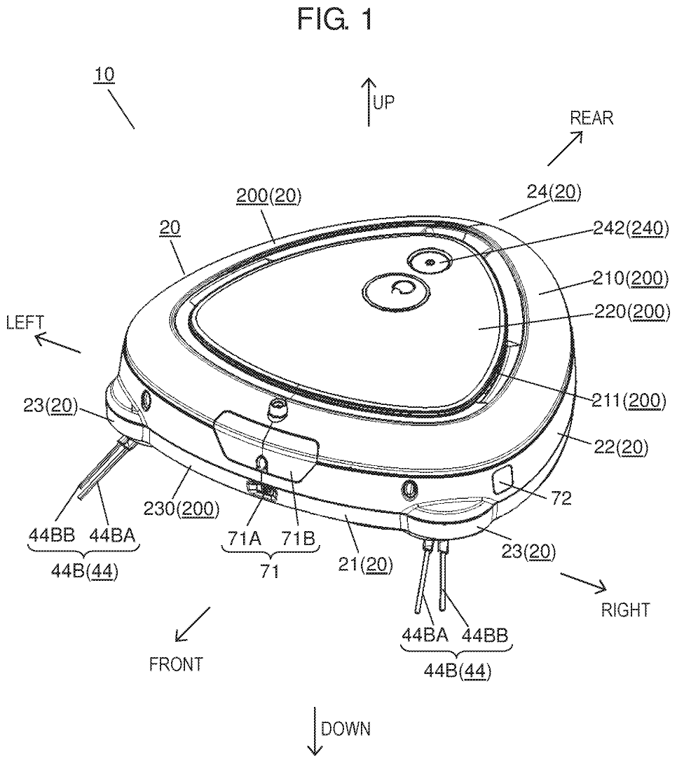

Hereinafter, a structure of autonomous cleaner 10 (merely referred to as “cleaner 10” in some cases) according to the present exemplary embodiment is described with reference to FIGS. 1 to 13.

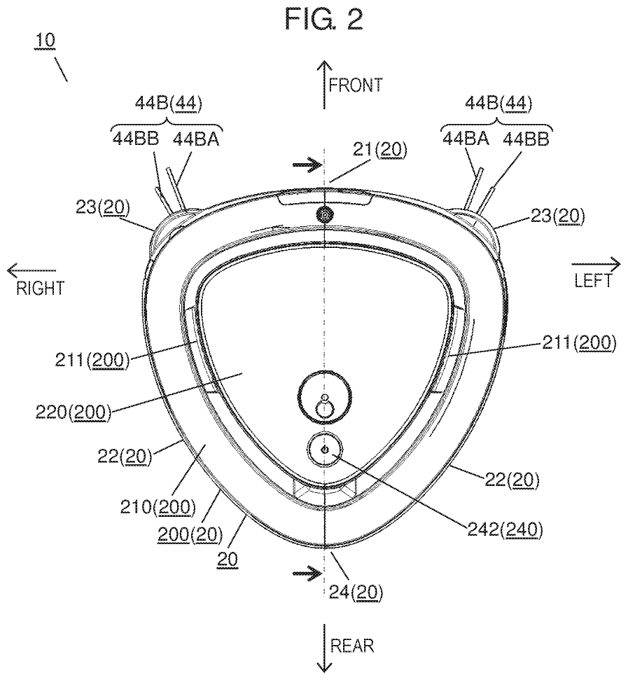

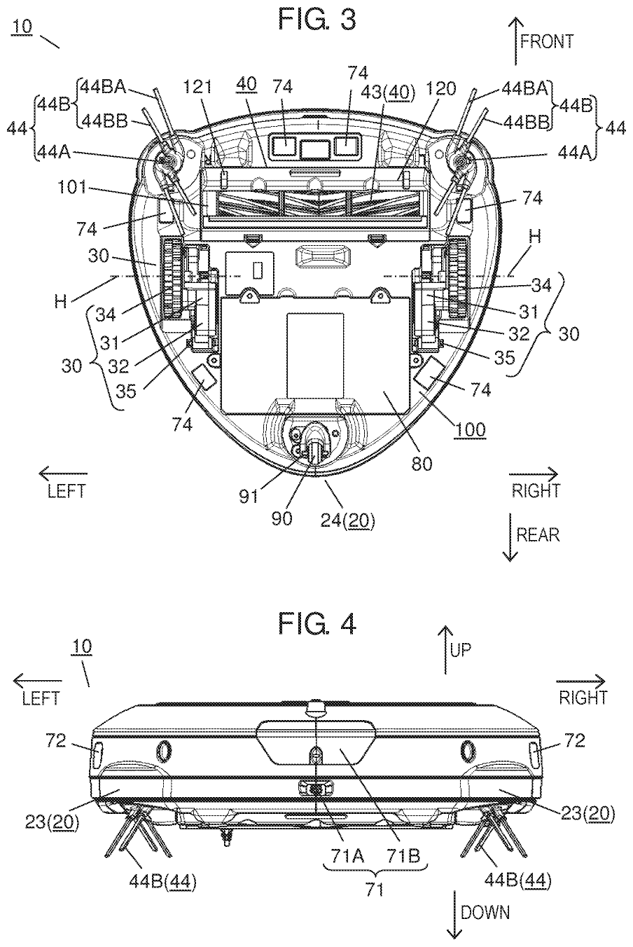

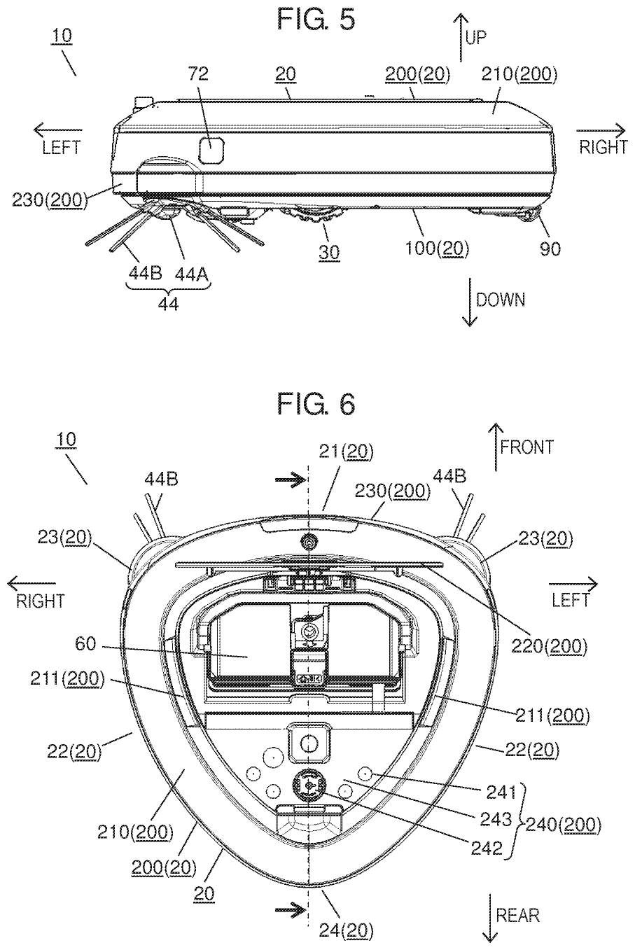

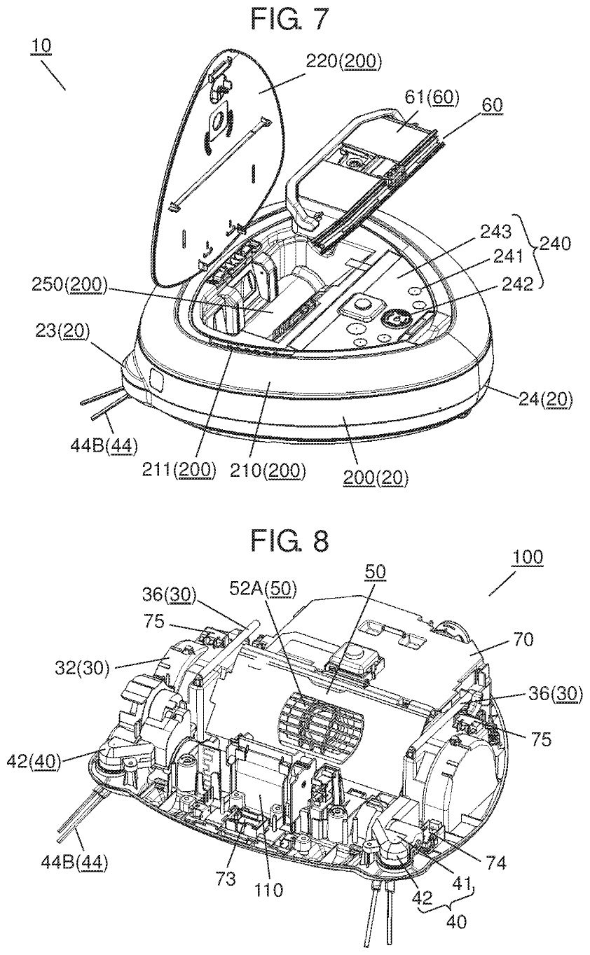

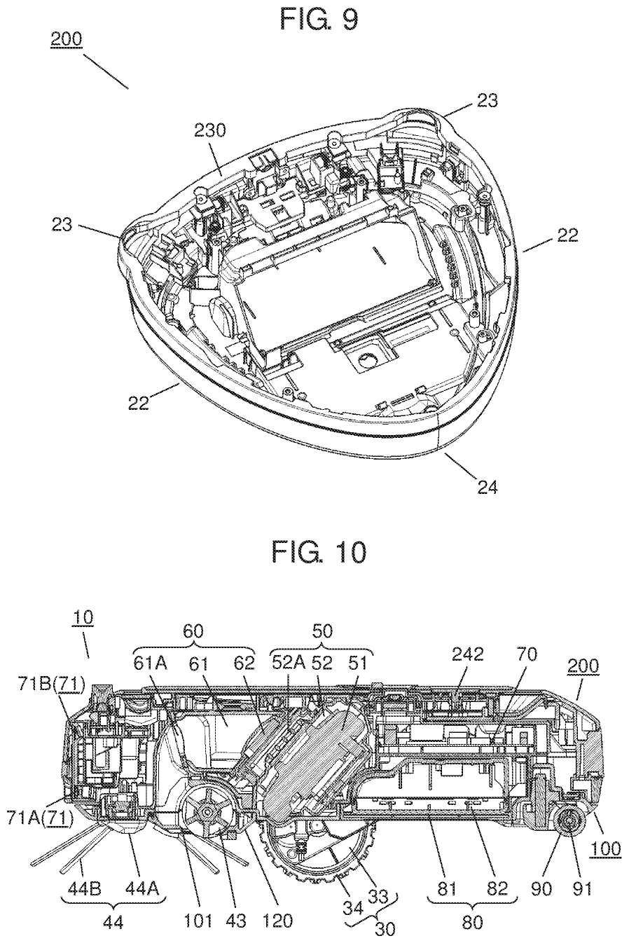

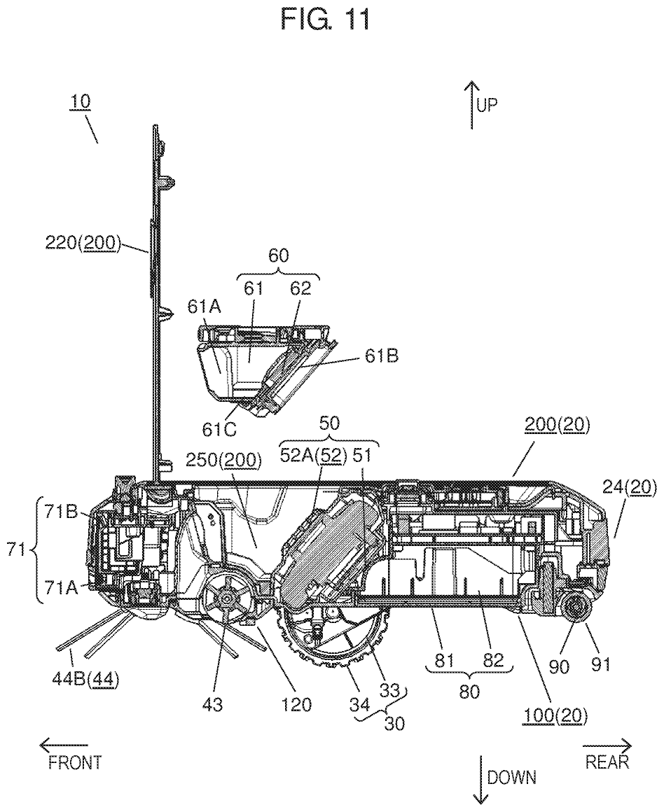

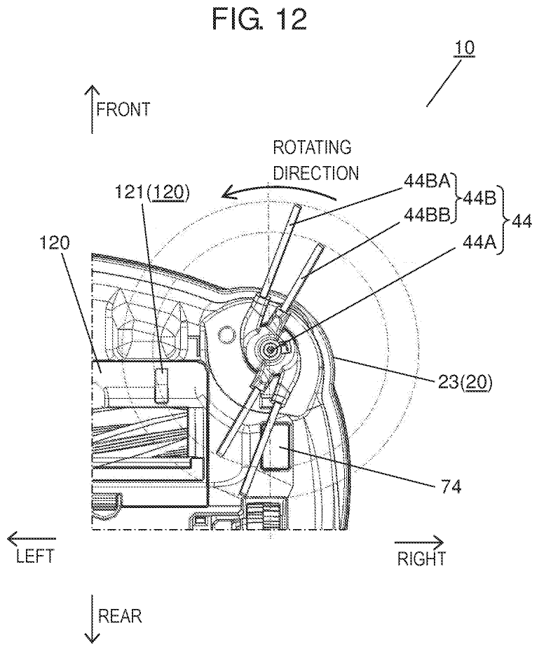

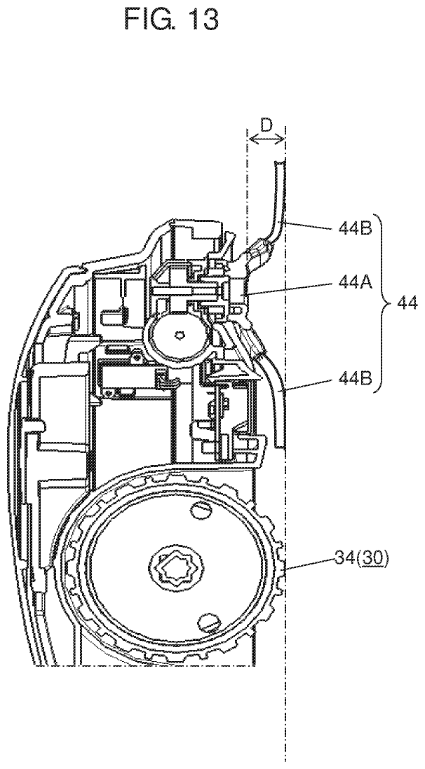

FIG. 1 is an overall perspective view of the autonomous cleaner according to the exemplary embodiment of the present invention. FIG. 2 is a plan view of the autonomous cleaner. FIG. 3 is a bottom view of the autonomous cleaner. FIG. 4 is a front view of the autonomous cleaner. FIG. 5 is a left side view of the autonomous cleaner. FIG. 6 is a plan view of the autonomous cleaner with a lid open. FIG. 7 is a perspective view of the autonomous cleaner of which a litter box unit is taken out. FIG. 8 is a perspective view of a lower unit of the autonomous cleaner. FIG. 9 is a perspective view of an upper unit of the autonomous cleaner. FIG. 10 is a left sectional view of the autonomous cleaner. FIG. 11 is a left sectional view of the autonomous cleaner of which the litter box unit is taken out. FIG. 12 is a partial view showing a rotating region of a side brush seen from a side of a bottom face of the autonomous cleaner. FIG. 13 is a sectional view of a relevant part of the autonomous cleaner.

As an example of autonomous cleaner 10 according to the present exemplary embodiment, a robot cleaner that autonomously travels on a surface to be cleaned in a target region and draws in dust such as litter existing on the surface to be cleaned is shown. Cleaner 10 includes a plurality of structural function blocks. An example of the target region is a room. An example of the surface to be cleaned is a floor surface of the room.

As shown in FIGS. 1 to 13, cleaner 10 according to the present exemplary embodiment includes body 20 mounted with following various component elements, cleaning unit 40, suction unit 50, litter box unit 60, a pair of drive units 30, control unit 70, power supply unit 80, and the like. Parts of drive units 30, a part of cleaning unit 40, litter box unit 60, suction unit 50, control unit 70, and power supply unit 80 are disposed in body 20.

In the following description, a side of front face 21 of body 20 is defined as a front side and a side of rear apex portion 24 is defined as a rear side as shown in the drawings. In the description, a side of body 20 close to the surface to be cleaned is defined as a lower side, an opposite side of body 20 is defined as an upper side, a right side of body 20 when seen from the side of front face 21 is defined as a right side, and a left side of body 20 is defined as a left side.

To put it concretely, cleaning unit 40 collects the litter existing in the target region such as the room. Suction unit 50 draws the collected litter into body 20. Litter box unit 60 stores the litter drawn in by suction unit 50.

As shown in FIG. 3, drive units 30 are paired units, for example, and provided on a side of the bottom face of body 20. Drive units 30 cooperate with caster 90 (described later) that rotates following rotation of drive units 30 to move body 20 in a predetermined direction. Control unit 70 controls operations of drive units 30, cleaning unit 40, suction unit 50, and the like. Power supply unit 80 supplies electric power to drive units 30, cleaning unit 40, suction unit 50, control unit 70, and the like.

Body 20 includes lower unit 100 (see FIG. 8) and upper unit 200 (see FIG. 9). Lower unit 100 forms an outside shape of a lower side of body 20. Upper unit 200 forms an outside shape of an upper side of body 20. By assembling lower unit 100 and upper unit 200, an outer contour of body 20 is formed.

Upper unit 200 includes cover 210, lid 220 (see FIGS. 1, 7), bumper 230, and the like. Cover 210 forms a main part of upper unit 200. Lid 220 is provided to the cover 210 such that lid 220 can be opened and closed. Bumper 230 is provided to front face 21 of cover 210. Bumper 230 is formed to be able to be displaced with respect to cover 210 and absorbs or mitigates an impact of a collision with an obstacle or the like.

As shown in FIG. 3, drive units 30 are disposed on a side of a bottom face of lower unit 100 and include a plurality of elements. The plurality of elements include a pair of tires 34, a pair of wheels 33 (see FIG. 10), a pair of traveling motors 31, a pair of housings 32, a pair of support shafts 35, and the like, for example. Tires 34 travel on the surface to be cleaned and move body 20. Wheels 33 retain tires 34. Traveling motors 31 give rotational torque to wheels 33. Each of housings 32 houses each of traveling motors 31. Each of housings 32 is housed in each of recessed portions (not shown) formed in lower unit 100. Each of housings 32 supports each of tires 34 with lower unit 100 such that tire 34 can rotate.

Wheels 33 are disposed on outer sides of traveling motors 31 in a width direction (longitudinal direction) of main brush 43. When wheels 33 are disposed in this manner, a longer distance is secured between right wheel 33 and left wheel 33 than when wheels 33 are disposed on inner sides of traveling motors 31. As a result, stability of body 20 during traveling and the like increases.

Cleaner 10 according to the present exemplary embodiment is operated by an opposed two-wheel driving method. In other words, cleaner 10 has right drive unit 30 and left drive unit 30 disposed to face each other in a width direction (left-right direction) of body 20. Rotating shaft H of right wheel 33 and rotating shaft H of left wheel 33 shown in FIG. 3 are parallel to support shafts 35 that turn drive units 30 and provided in a same direction. Moreover, rotating shafts H of left and right wheels 33 are respectively fixed to suspensions 36 (see FIG. 8) by support shafts 35. Suspensions 36 function as cushions that buffer vibrations applied to body 20 from recessions and protrusions on the surface to be cleaned during driving.

Lower unit 100 has above-described caster 90 on a side of a lower face of a rear part and near rear apex portion 24 of body 20. Caster 90 is rotatably supported on lower unit 100 around support shaft 91. In other words, body 20 is supported at three points, i.e., left and right drive units 30 and caster 90 on the surface to be cleaned. In this way, it is possible to constantly move body 20 in a stable state.

As shown in FIGS. 3 and 8, cleaning unit 40 is disposed at lower unit 100 and includes a plurality of elements. The plurality of elements include brush drive motor 41, gearboxes 42, main brush 43, side brushes 44, and the like, for example. Brush drive motor 41 and gearboxes 42 are disposed inside body 20. Main brush 43 is disposed at suction port 101 of body 20. As shown in FIG. 2, side brushes 44 are respectively disposed at left and right front apex portions 23 at intersection points of front face 21 and each of left and right side faces 22 of body 20. Each of side brushes 44 includes brush shaft 44A and bristle bundles 44B fixed to brush shaft 44A and provided to protrude downward from body 20. Brush shaft 44A is fixed to gearbox 42 (see FIG. 8).

As shown in FIG. 12, each of side brushes 44 is formed by four bristle bundles 44B, i.e., two pairs of first bristle bundle 44BA and second bristle bundle 44BB having different lengths, for example. At this time, first bristle bundle 44BA is disposed at a position advanced from second bristle bundle 44BB in a rotating direction. First bristle bundle 44BA is formed to be longer than second bristle bundle 44BB. Second bristle bundle 44BB has at least a length that is sufficient to bring a tip end portion of second bristle bundle 44BB into contact with napped cleaning fabric 121 (described later, see FIG. 3) in rotation. To put it concretely, first bristle bundle 44BA is about 52 mm in length and second bristle bundle 44BB is about 44 mm in length.

One pair of bristle bundles 44B and the other pair of bristle bundles 44B are at two-fold rotationally symmetric positions (at 180°) about an axis of rotation of brush shaft 44A.

Furthermore, first bristle bundle 44BA and second bristle bundle 44BB forming each pair of bristle bundles 44B are planted at different angles with respect to brush shaft 44A. To put it concretely, as shown in FIG. 12, first bristle bundle 44BA and second bristle bundle 44BB are planted in brush shaft 44A at different rotation angles in the rotating direction to form a substantially V shape (including a V shape). For example, first bristle bundle 44BA is planted in brush shaft 44A at the rotation angle that is advanced 8° to 10° from second bristle bundle 44BB in the rotating direction.

Moreover, second bristle bundle 44BB is planted at an inclination angle from a horizontal direction that is different from an inclination angle of first bristle bundle 44BA by 12°, for example, to be inclined further downward than first bristle bundle 44BA in a vertical direction. To put it concretely, first bristle bundle 44BA is planted at the inclination angle of 31° and second bristle bundle 44BB is planted at the inclination angle of 43° from the horizontal direction of brush shaft 44A.

In other words, in the present exemplary embodiment, the lengths and the angles of first bristle bundle 44BA and second bristle bundle 44BB forming each pair of bristle bundles 44B are determined appropriately so that a collecting area in the rotation becomes large.

As described above, side brushes 44 are disposed at front apex portions 23 protruding at left and right front portions of cleaner 10 (see FIG. 1). Being disposed at such positions, side brushes 44 can collect the dust in corners of the room with higher collecting performance.

As shown in FIG. 8, brush drive motor 41 and gearboxes 42 are mounted to lower unit 100. An output shaft (not shown) of brush drive motor 41 is connected to gearboxes 42, main brush 43 (see FIG. 3), and left and right front side brushes 44. In this way, a rotation output of brush drive motor 41 is transmitted to main brush 43 and side brushes 44.

A longitudinal length of main brush 43 is substantially equal to a longitudinal length of suction port 101 formed in lower unit 100. Main brush 43 is rotatably supported on lower unit 100 by bearings (not shown). Bearings are provided to gearboxes 42 and/or lower unit 100, for example. Main brush 43 rotates in such a direction as to send the litter, for example, out to a front side of body 20.

As shown in FIGS. 11 and 12, main brush 43 is protected by brush cover 120. Brush cover 120 has napped cleaning fabrics 121 disposed on the side close to the surface to be cleaned. Napped cleaning fabrics 121 clean the floor surface and also clean side brushes 44 by coming in contact with side brushes 44 that are rotating. In other words, napped cleaning fabrics 121 are intended to wipe off the dust attached to side brushes 44 during the rotation. As a result, portions of bristle bundles 44B of side brushes 44 that come in contact with the floor surface are constantly maintained without the dust. In other words, when the dust is collected while the body is operating forward and rearward, relatively heavy dust is collected and drawn into suction port 101 via side brushes 44 during the rotation of side brushes 44. However, light and fine dust such as sebum and fibers, for example, is liable to remain attached to side brushes 44. Therefore, the fine dust is not reliably drawn and removed into suction port 101 and may be swept outside again by centrifugal separation by side brushes 44. Therefore, in the present exemplary embodiment, the napped cleaning fabrics are provided in the rotating regions of side brushes 44 and the dust attached to the portions of side brushes 44 that come in contact with the floor surface can be wiped off by napped cleaning fabrics 121 and drawn in and removed.

Moreover, as shown in FIG. 13, distance D between brush shaft 44A of each of side brushes 44 and the floor surface is set between 10 mm and 18 mm inclusive when cleaner 10 according to the present exemplary embodiment is placed on the horizontal flat surface to be cleaned.

If distance D exceeds 18 mm, first bristle bundles 44BA and second bristle bundles 44BB of each of side brushes 44 are planted at larger than about 60° from the horizontal direction of brush shaft 44A in the vertical direction. In this way, areas of the surface to be cleaned with which first bristle bundles 44BA and second bristle bundles 44BB come in contact while curved reduce. As a result, a cleaning area by each of side brushes 44 reduces, which may impair cleaning efficiency. To put it concretely, distances D from the floor surface are set to 12 mm, for example, when tires 34 are recessed the most in cleaner 10 according to the present exemplary embodiment. Normally, cleaner 10 is formed such that body 20 is lifted by suspensions 36 so as to acquire step climbing-over performance. Therefore, when tires 34 protrude the most from body 20, tires 34 protrude about 40 mm from body 20. However, in practice, a step sensor is actuated when the distance from the floor surface becomes long. Furthermore, suspensions 36 cannot lift body 20 to a height of 40 mm because of a weight of body 20. Moreover, if the distance from the floor surface becomes long, side brushes 44 separate from the floor surface and the cleaning areas reduce. Therefore, in consideration of the above points, distance D is preferably less than or equal to about 20 mm to 25 mm and more preferably less than or equal to 18 mm. On the other hand, if distance D is shorter than 10 mm that is close to the floor surface, side brushes 44 and a carpet with a soft base material or thick pile become more liable to get entangled with each other when body 20 comes over the carpet. Moreover, when cleaner 10 tries to climb over a step of the carpet, brush shafts 44A come in contact with the step first and cleaner 10 cannot climb over the carpet.

Therefore, brush shafts 44A of side brushes 44 that are rotating bodies are disposed at distances of about 10 mm to 18 mm inclusive from the floor surface. In this way, entanglement of brush shafts 44A and the carpet and the like with each other can be suppressed. Furthermore, it is possible to avoid a collision between each of brush shafts 44A and the step corresponding to a thickness of the carpet, for example.

As shown in FIGS. 8, 10, and 11, suction unit 50 is disposed at lower unit 100 and includes a plurality of elements. To put it concretely, suction unit 50 is disposed behind litter box unit 60 and in front of power supply unit 80, for example. The plurality of elements include fan case 52, electric fan 51 disposed in fan case 52, and the like, for example. Fan case 52 has intake port 52A that is disposed on a front side and in contact with outlet port 61B of litter box unit 60. Electric fan 51 draws in inside air from outlet port 61B of litter box unit 60 through intake port 52A. The drawn-in air is exhausted to a rear outside of electric fan 51. To put it concretely, air exhausted from electric fan 51 passes through a space inside fan case 52 and a space inside body 20. The air is exhausted outside from body 20 through exhaust port 211 (see FIG. 7) formed in upper unit 200.

As shown in FIGS. 10 and 11, litter box unit 60 is disposed behind main brush 43, in front of suction unit 50, and between paired drive units 30 (see FIG. 3) in body 20. When lid 220 is opened, litter box unit 60 can be detachably mounted to body 20. In other words, litter box unit 60 has such a detachable structure as to be able to be mounted to and detached from body 20.

Litter box unit 60 is housed in litter box housing 250 and includes a plurality of elements (see FIG. 11). The plurality of elements include litter box 61 that catches the dust, for example, and has inlet port 61A, outlet port 61B, and bottom portion 61C, filter 62 that collects the fine dust, and the like.

Litter box unit 60 functions as follows.

First, the dust on the floor surface is drawn in with air by suction unit 50 through suction port 101 (see FIG. 3) of cleaning unit 40. The drawn-in air including the dust comes into litter box 61 from inlet port 61A via duct 110 (see FIG. 8) provided to lower unit 100. The large dust coming into litter box 61 accumulates on bottom portion 61C. On the other hand, out of air including the fine dust (small dust and the like) and coming into litter box 61, the small dust is filtered out with filter 62 of suction unit 50 in contact with outlet port 61B of litter box 61. The air out of which the dust is filtered is exhausted outside through exhaust port 211 (see FIG. 7) of body 20 via suction unit 50. In this way, the dust is collected in litter box unit 60 in a disposable state.

As shown in FIGS. 8 and 10, control unit 70 is disposed behind suction unit 50 in body 20.

As shown in FIGS. 1 to 8, cleaner 10 according to the present exemplary embodiment includes a plurality of sensors. The plurality of sensors include obstacle detection sensor 71, distance measurement sensors 72, collision detection sensor 73, floor surface detection sensors 74, bogged wheel detection switches 75, and the like, for example.

Obstacle detection sensor 71 (see FIG. 1) is provided at a front center of body 20 and detects an obstacle ahead of body 20. Obstacle detection sensor 71 includes laser light emitter 71A and laser light receiver 71B. To put it concretely, obstacle detection sensor 71 radiates laser light forward from laser light emitter 71A. Then, laser light receiver 71B receives and reads reflected light from the obstacle or the like. In this way, obstacle detection sensor 71 senses the obstacle in front of body 20.

Two distance measurement sensors 72, for example, (see FIG. 4) are provided to front left and right parts of the side faces of body 20 and detect distances between obstacles beside the side faces and body 20. Collision detection sensor 73 (see FIG. 8) is provided at a front center of lower unit 100 of body 20 and detects a collision between body 20 and an object around body 20. The plurality of floor surface detection sensors 74 (see FIG. 3) are provided to respective parts of lower unit 100 of body 20 and detect whether the surface to be cleaned exists on the side of the bottom face of body 20. Bogged wheel detection switches 75 (see FIG. 8) are respectively disposed behind left and right drive units 30 and sense that tires 34 and the like get bogged.

Obstacle detection sensor 71, distance measurement sensors 72, collision detection sensor 73, floor surface detection sensors 74, and bogged wheel detection switches 75 respectively output detection signals to control unit 70. Control unit 70 controls respective units based on the input detection signals.

As shown in FIG. 6, cleaner 10 according to the present exemplary embodiment includes interface unit 240. Interface unit 240 includes panel 241, operation button 242, display 243, and the like, for example. A user can recognize respective operated conditions and operating states of cleaner 10 by use of interface unit 240.

To put it concretely, display 243 of interface unit 240 displays error states and the like of cleaner 10 detected by obstacle detection sensor 71, distance measurement sensors 72, collision detection sensor 73, floor surface detection sensors 74, and bogged wheel detection switches 75. In this way, the user can recognize error conditions of cleaner 10 by use of display 243.

In addition, the user can designate respective operations of body 20 by use of operation button 242 and respective buttons of panel 241 of interface unit 240.

As shown in FIG. 10, cleaner 10 according to the present exemplary embodiment further includes power supply unit 80 having a plurality of elements. Power supply unit 80 supplies the electric power to drive units 30, cleaning unit 40, suction unit 50, and control unit 70 described above. To put it concretely, power supply unit 80 is disposed behind a center in a front-rear direction of body 20 and behind suction unit 50. The plurality of elements include battery case 81, storage battery 82, and the like, for example. Battery case 81 is mounted to lower unit 100. Storage battery 82 is housed in battery case 81. As an example of storage battery 82, a secondary battery such as a lithium battery is shown.

As described above, autonomous cleaner 10 according to the present exemplary embodiment is the autonomous cleaner that collects the dust on the floor surface. To put it concretely, cleaner 10 includes, inside cleaner 10, suction unit 50 that generates suction air and litter box unit 60 that collects the dust. On the side of the bottom face of cleaner 10, suction port 101 mounted with main brush 43 that collects the dust and side brushes 44 that are disposed at left and right positions in front of suction port 101 to collect the dust on the floor surface into suction port 101 are mounted. Cleaner 10 generates a flow of air that draws in the dust by use of suction unit 50. In this way, cleaner 10 is formed to draw in the dust on the floor surface through suction port 101 and collect the drawn-in dust into litter box unit 60.

Cleaner 10 further includes drive units 30, power supply unit 80, control unit 70, and the like. Drive units 30 are provided at left and right positions on the side of the bottom face of cleaner 10 and includes tires 34 that are used for forward and rearward movements and leftward and rightward turns on the floor surface. Power supply unit 80 supplies the electric power to suction unit 50, traveling motors 31 mounted to drive units 30, and the like.

Control unit 70 has obstacle detection sensor 71, distance measurement sensors 72, collision detection sensor 73, floor surface detection sensors 74, and the like for detecting the obstacle and the like and is formed to control suction unit 50, drive units 30, and the like based on the detection signals from the sensors. In this way, cleaner 10 can clean while traveling on the surface to be cleaned by driving tires 34 of drive units 30 under control of control unit 70.

Cleaner 10 according to the present exemplary embodiment includes at least the pair of side brushes 44 disposed on the side of the bottom face of cleaner 10. To put it concretely, side brushes 44 are disposed at left and right front apex portions 23 of cleaner 10. A rotation trajectory of right side brush 44 and a rotation trajectory of left side brush 44 respectively turn along an outer periphery of cleaner 10 and turn in directions from front face 21 toward suction port 101.

In other words, left and right side brushes 44 rotate in the opposite directions. In this way, while cleaner 10 is moving forward, side brushes 44 rake up the dust toward suction port 101. As a result, the dust on the floor surface is collected by cleaner 10 and the room is cleaned up.

Each of side brushes 44 includes two pairs of bristle bundles 44B (four bristle bundles 44B) and brush shaft 44A. Each pair including two bristle bundles 44B is formed by putting long and short different kinds of first bristle bundle 44BA and second bristle bundle 44BB together. Longer first bristle bundle 44BA has a larger radius of rotation and can pick up distant dust. On the other hand, shorter second bristle bundle 44BB has a smaller radius of rotation and can more reliably pick up nearby dust. First bristle bundle 44BA and second bristle bundle 44BB are respectively planted in brush shaft 44A at the different rotation angles or the different inclination angle in the rotating direction and the vertical direction. In this way, it is possible to widely cover the collecting area for the dust on the floor surface.

Furthermore, brush cover 120 has napped cleaning fabrics 121 in the rotating regions of bristle bundles 44B of side brushes 44. Therefore, napped cleaning fabrics 121 and bristle bundles 44B rotate while coming in contact with napped cleaning fabrics 121. In this way, the dust attached to bristle bundles 44B during the rotation of side brushes 44 is wiped off as a result of contact with napped cleaning fabrics 121. The wiped-off dust is drawn into litter box unit 60 through suction port 101. As a result, the dust such as the fine dust attached to bristle bundles 44B is prevented from being swept outside cleaner 10 again by centrifugal forces of side brushes 44.

In the cleaner according to the present exemplary embodiment, brush shafts 44A of side brushes 44 are disposed at positions that are between 10 mm and 18 mm inclusive from the floor surface. In this way, as compared with a prior-art autonomous cleaner having brush shafts disposed at distances of about 5 mm, it is possible to suppress the entanglement of the carpet or the like with bristle bundles 44B. Moreover, in climbing over the steps or the like, a frequency of collisions with the steps or the like can be reduced. In this way, it is possible to achieve the cleaner with high reliability and excellent cleaning performance.

According to an aspect, cleaner 10 in the present exemplary embodiment includes the plurality of drive units 30 that cause cleaner 10 to travel and the plurality of drive units 30 include first drive unit 30 and second drive unit 30. First drive unit 30 and second drive unit 30 may have coaxial axes of rotation (not shown). In this case, respective drive units 30 can be driven independently.

According to an aspect, cleaner 10 in the present exemplary embodiment may include control unit 70 that controls the plurality of drive units 30 and control unit 70 may control first drive unit 30 and second drive unit 30 such that body 20 forms at least a part of a rectangular trajectory.

With the above-described structure, by separately operating respective drive units 30, it is possible to move a front part of cleaner 10 to or close to an apex of the corner of the region to be cleaned. In other words, it is possible to bring suction port 101 of cleaner 10 even closer to the apex of the corner of the target region. As a result, it is possible to reliably draw in and clean more litter existing in the corners of the target region.

As described above, the autonomous cleaner according to the present invention includes the body, the plurality of side brushes that are provided to the bottom face of the body and sweep up the dust on the floor surface, and the napped cleaning fabrics that are provided in the rotating regions of the side brushes and wipe off the dust attached to the side brushes. Each of the side brushes includes the brush shaft disposed at the position that is the predetermined distance above the floor surface and the pair of bristle bundles having the different lengths. The shorter bristle bundle in the pair is formed to have the length that is sufficient to bring at least the tip end portion of the shorter bristle bundle into contact with the napped cleaning fabric.

With this structure, the dust attached to the side brushes is wiped off by the napped cleaning fabrics during the rotation. Therefore, it is possible to prevent the dust attached to the side brushes from being swept outside the body again due to the centrifugal forces. The bristle bundles provided to each of the side brushes are short because the bristle bundles have such lengths that the tip end portions of the bristle bundles come in contact with the napped cleaning fabric. As a result, it is possible to suppress the entanglement of the dust such as hairs and fibers.

In the autonomous cleaner according to the present invention, the predetermined distance only needs to be between 10 mm and 18 mm inclusive. In this way, it is possible to suppress the entanglement of the carpet and the like with the brush shafts. Moreover, it is possible to substantially reduce the collisions of the brush shafts of the side brushes with the steps during climbing over of the steps. As a result, it is possible to prevent the brush shafts of the side brushes from getting scratched or damaged.

In the autonomous cleaner according to the present invention, the side brushes may be disposed at the left and right front protruding positions of the body. In this way, it is possible to more reliably collect the dust existing in the corners of the room.

In the autonomous cleaner according to the present invention, the pair of bristle bundles includes the first bristle bundle and the second bristle bundle formed by planting bristles. The first bristle bundle may be planted at the predetermined rotation angle in the rotating direction of the side brush with respect to the second bristle bundle.

In the autonomous cleaner according to the present invention, the predetermined different rotation angle may be between 8° and 10° inclusive.

In the autonomous cleaner according to the present invention, the pair of bristle bundles includes the first bristle bundle and the second bristle bundle formed by planting bristles. The first bristle bundle may be planted at the predetermined different inclination angle in the vertical direction from the second bristle bundle.

In the autonomous cleaner according to the present invention, the predetermined different inclination angle may be between 31° and 43° inclusive.

With these structures, it is possible to reduce a maintenance frequency of the side brushes while securing the collecting performance.

### INDUSTRIAL APPLICABILITY

According to the autonomous cleaner in the present invention, it is possible to suppress the entanglement of the dust with the bristle bundles of the side brushes, which prevents the bristle bundles from curling and falling out and extends life of the bristle bundles. Therefore, the present invention can be applied to various types of autonomous cleaners in which a lower frequency of maintenance of side brushes is desired and which are used in different environments irrespective of whether the cleaners are for home use or professional use.

### REFERENCE MARKS IN THE DRAWINGS

10: autonomous cleaner (cleaner)

20: body

21: front face

22: side face

23: front apex portion

24: rear apex portion

30: drive unit

31: traveling motor

32: housing

33: wheel

34: tire

35: support shaft

36: suspension

40: cleaning unit

41: brush drive motor

42: gearbox

43: main brush

44: side brush

44A: brush shaft

44B: bristle bundle

44BA: first bristle bundle

44BB: second bristle bundle

50: suction unit

51: electric fan

52: fan case

52A: intake port

60: litter box unit

61: litter box

61A: inlet port

61B: outlet port

61C: bottom portion

62: filter

70: control unit

71: obstacle detection sensor

71A: laser light emitter

71B: laser light receiver

72: distance measurement sensor

73: collision detection sensor

74: floor surface detection sensor

75: bogged wheel detection switch

80: power supply unit

81: battery case

82: storage battery

90: caster

91: support shaft

100: lower unit

101: suction port

110: duct

120: brush cover

121: napped cleaning fabric

200: upper unit

210: cover

211: exhaust port

220: lid

230: bumper

240: interface unit

241: panel

242: operation button

243: display

250: litter box housing

1. An autonomous cleaner comprising:
a body;
a side brush that is provided to a bottom face of the body and sweeps up dust on a floor surface; and
a napped cleaning fabric that is provided in a rotating region of the side brush and wipes off the dust attached to the side brush,
wherein the side brush includes a brush shaft disposed at a position that is a predetermined distance above the floor surface and a pair of bristle bundles having different lengths, and
a shorter bristle bundle in the pair is formed to have a length that is sufficient to bring at least a tip end portion of the shorter bristle bundle into contact with the napped cleaning fabric.

2. The autonomous cleaner according to claim 1, wherein the predetermined distance is between 10 mm and 18 mm inclusive.

3. The autonomous cleaner according to claim 1, wherein the side brush is disposed at a left or right front protruding position of the body.

4. The autonomous cleaner according to claim 1, wherein the pair of bristle bundles includes a first bristle bundle and a second bristle bundle formed by planting bristles, and the first bristle bundle is planted at a predetermined different rotation angle in a rotating direction of the side brush from the second bristle bundle.

5. The autonomous cleaner according to claim 4, wherein the predetermined different rotation angle is between 8° and 10° inclusive.

6. The autonomous cleaner according to claim 1, wherein
the pair of bristle bundles includes a first bristle bundle and a second bristle bundle formed by planting bristles, and
the first bristle bundle is planted at a predetermined different inclination angle in a vertical direction from the second bristle bundle.

7. The autonomous cleaner according to claim 6, wherein the predetermined different inclination angle is between 31° and 43° inclusive.
